(19) United States
(12) Patent Application Publication
(10) Pub. No.: US 2024/0321144 A1
(43) Pub. Date: Sep. 26, 2024

(54) PROTECTIVE CASE

(71) Applicant: George-Michael Huyke-Phillips, Malibu, CA (US)

(72) Inventor: George-Michael Huyke-Phillips, Malibu, CA (US)

(21) Appl. No.: 18/612,377

(22) Filed: Mar. 21, 2024

Related U.S. Application Data
(60) Provisional application No. 63/492,215, filed on Mar. 24, 2023.

(51) Int. Cl. G09F 1/12; G09F 1/10

(52) U.S. Cl. CPC G09F 1/12; G09F 2001/106

(57) ABSTRACT

A protective case is provided that includes a front cover removably coupled to a back cover. The front cover and back cover may be configured to retain a collectible between the front cover and the back cover. The front cover and/or back cover may be configured such that a viewer may view the inserted collectible through the front cover and/or the back cover when the collectible is positioned between the front cover and the back cover and when the front cover is coupled to the back cover.

### CROSS-REFERENCE TO RELATED APPLICATION

The present application claims priority to U.S. Provisional Patent Application No. 63/492,215, filed Mar. 24, 2023, titled “PROTECTIVE CASE,” the disclosure of which is herein incorporated by reference in its entirety.

### BACKGROUND

A trading or sports card are collectibles that are bought by users to save to increase in value. Trading cards are desirably shown to others. Trading cards, when handled, however, may be damaged. Owners of trading cards, especially trading cards that are likely to increase in value, may put the trading cards in protective covers in order to protect the trading cards.

Conventional protective trading card covers may include a plastic pouch with an opening on one side through which the card may slide between two attached sheets of plastic. Owners of trading cards may also put their trading cards within a picture frame or other display case.

Conventional trading card protective cases have their drawbacks. For example, conventional trading card protective cases may be configured such that they allow for easy handling of the trading card and/or they may not provide the best protection for the trading card.

### SUMMARY

A protective case is provided that includes a front cover removably coupled to a back cover. The front cover and back cover may be configured to retain a collectible between the front cover and the back cover. The front cover and/or back cover may be configured to view the inserted collectible when the collectible is positioned between the front cover and the back cover and the front cover is attached to the back cover.

According to an object of the present disclosure, a protective case is provided. The protective case may comprise a front cover and a back cover removably coupled to the front cover. The front cover and the back cover, when coupled, may form a recess configured to receive an object for insertion therein. The protective case may comprise a securing mechanism, coupled to the front cover and the back cover, configured to removably couple the front cover to the back cover.

According to an exemplary embodiment, the securing mechanism may comprise a plurality of magnets inserted in the front cover.

According to an exemplary embodiment, the securing mechanism may comprise a plurality of metal portions inserted in the back cover that are positioned to align with the plurality of magnets inserted in the front cover when the front cover is coupled to the back cover.

According to an exemplary embodiment, the metal portions may be magnetic.

According to an exemplary embodiment, the recess may comprise an indentation in the back cover shaped to accommodate the object.

According to an exemplary embodiment, the back cover may comprise one or more second indentations.

According to an exemplary embodiment, the indentation may be rectangular in shape.

According to an exemplary embodiment, a portion of each of the one or more second indentations may overlap with the indentation so that the one or more second indentations extends a perimeter of the indentation.

According to an exemplary embodiment, the back cover may comprise a flange extending along a terminal end of the back cover.

According to an exemplary embodiment, the flange may comprise one or more apertures.

According to an exemplary embodiment, the front cover may comprise one or more protections.

According to an exemplary embodiment, the one or more projections may be configured to be positioned in the one or more apertures.

According to an exemplary embodiment, the front cover and the back cover may be rigid.

According to an exemplary embodiment, the front cover may be transparent.

According to an exemplary embodiment, the front cover and the back cover may be transparent.

According to an exemplary embodiment, the securing mechanism may comprise a plurality of magnets inserted in the front cover.

According to an exemplary embodiment, the plurality of magnets may be T-shaped.

According to an exemplary embodiment, the back cover may comprise an opening.

According to an exemplary embodiment, the opening may comprise an indentation configured to assist in separating the front cover from the back cover.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a perspective view of an exemplary embodiment of the protective case in a closed configuration with an enclosed exemplary trading card seen therein, according to embodiments described herein.

FIG. 2 illustrates a perspective view of the exemplary embodiment of the protective case of FIG. 1 in which a front cover is removed from the back cover exposing the trading card seen therein, according to embodiments described herein.

FIG. 3 illustrates a front plan view of an exterior side of the front cover of a protective case, according to a first embodiment described herein.

FIG. 4 illustrates a front plan view of an exterior side of the back cover of the protective case, according to a first embodiment described herein.

FIG. 5 illustrates a bottom plan view of the front cover of the exemplary protective case of FIG. 3, according to the first embodiment described herein.

FIG. 6 illustrates a bottom plan view of the back cover of the exemplary protective case of FIG. 4, according to the first embodiment described herein.

FIG. 7 illustrates a front plan view of an exterior side of the front cover, according to a second embodiment described herein.

FIG. 8 illustrates a back plan view of an exterior side of the back cover of the protective case, according to a second embodiment described herein.

FIG. 9 illustrates a bottom plan view of the front cover of the exemplary protective case of FIG. 7, according to the second embodiment described herein.

FIG. 10 illustrates a bottom plan view of the back cover of the exemplary protective case of FIG. 8, according to the second embodiment described herein.

FIG. 11 illustrates a top plan view of the front cover of a protective case of FIG. 3, according to the first embodiment described herein.

FIG. 12 illustrates a top plan view of the back cover of the protective case of FIG. 4, according to the first embodiment described herein.

FIG. 13 illustrates a back plan view of an interior side of the front cover of the exemplary protective case of FIG. 3, according to the first embodiment described herein.

FIG. 14 illustrates a back plan view of an interior side of the back cover of the exemplary protective case of FIG. 4, according to the first embodiment described herein.

FIG. 15 illustrates a top plan view of the front cover of a protective case of FIG. 7, according to the second embodiment described herein.

FIG. 16 illustrates a top plan view of the back cover of the protective case of FIG. 8, according to the second embodiment described herein.

FIG. 17 illustrates a back plan view of an interior side of the front cover of the exemplary protective case of FIG. 7, according to the second embodiment described herein.

FIG. 18 illustrates a back plan view of an interior side of the back cover of the exemplary protective case of FIG. 8, according to the second embodiment described herein.

FIG. 19 illustrates a first side plan view of the front cover of the protective case of FIG. 3, according to the first embodiment described herein.

FIG. 20 illustrates a first side plan view of the back cover of the protective case of FIG. 4, according to the first embodiment described herein.

FIG. 21 illustrates a second side plan view of the front cover of the protective case of FIG. 3, according to the first embodiment described herein.

FIG. 22 illustrates a second side plan view of the back cover of the protective case of FIG. 4, according to the first embodiment described herein.

FIG. 23 illustrates a first side plan view of the front cover of the protective case of FIG. 7, according to the second embodiment described herein.

FIG. 24 illustrates a first side plan view of the back cover of the protective case of FIG. 8, according to the second embodiment described herein.

FIG. 25 illustrates a second side plan view of the front cover of the protective case of FIG. 7, according to the second embodiment described herein.

FIG. 26 illustrates a second side plan view of the back cover of the protective case of FIG. 8, according to the second embodiment described herein.

FIG. 27 illustrates a perspective view of a third exemplary embodiment of the protective case in which a front cover is removed from the back cover exposing the interior sides of the front cover and back cover, according to embodiments described herein.

FIG. 28 illustrates a perspective view of a fourth exemplary embodiment of the protective case in which a front cover is removed from the back cover exposing collectible retained within the protective cover, according to embodiments described herein.

FIG. 29 illustrates a perspective view of a fifth exemplary embodiment of the protective case in which a front cover is removed from the back cover exposing collectible retained within the protective cover, according to embodiments described herein.

FIG. 30 illustrates a perspective view of a sixth exemplary embodiment of the protective case in which a front cover is removed from the back cover to show the interior sides of the respective covers, according to embodiments described herein.

FIG. 31 illustrates example geometric shapes, according to embodiments described herein.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

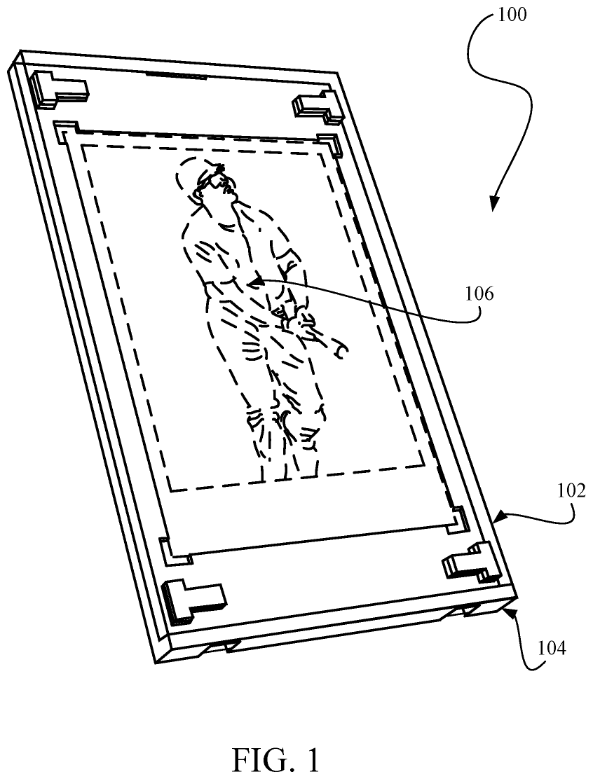

FIG. 1 illustrates a perspective view of an exemplary embodiment of a protective case 100 in a closed configuration with an enclosed exemplary collectible 106 seen therein, according to embodiments described herein. The illustrated protected collectible 106 (e.g., a trading card, as seen in FIG. 1) is illustrated in dashed lines representing that the collectible 106 is not intended to be part of the instant present disclosure. The protective case 100 may be configured to retain or hold different collectibles 106, such as, for example, trading cards, business cards, sports cards, pictures, comic books, magazines, vinyl records, documents, letters, photographs, and/or other collectibles.

Exemplary embodiments described herein include a front cover 102 and a back cover 104 configured to protect a collectible 106 positioned between the front cover 102 and back cover 104. The front cover 102 is configured with a transparent portion for a viewer to see through the front cover 102 and see the enclosed collectible 106. The back cover 104 may be configured to be transparent, translucent, opaque, or a combination thereof. The back cover 104 may be configured to provide a decorative backdrop to the positioned collectible 106. As illustrated, the back cover 104 and/or the front cover 102 may be transparent.

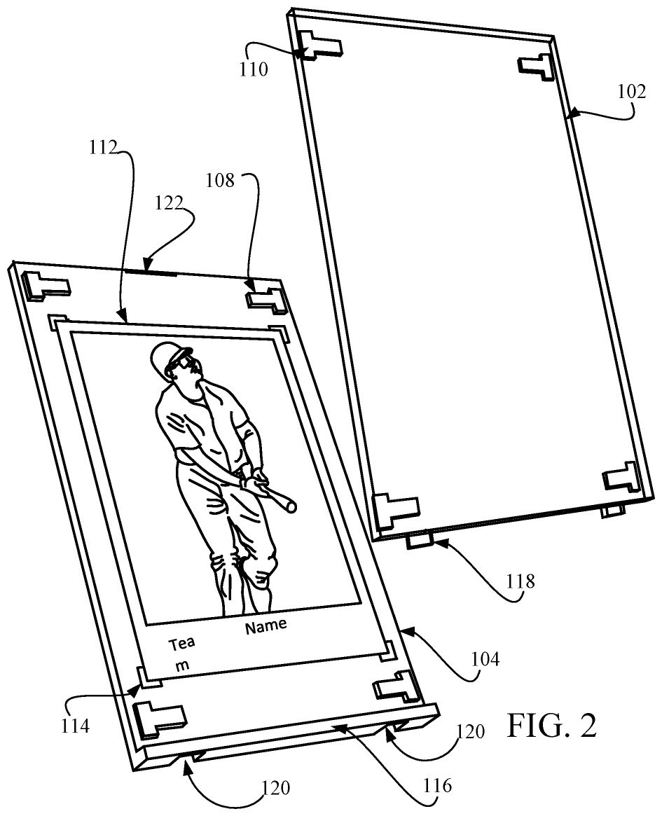

FIG. 2 illustrates a perspective view of the exemplary embodiment of the protective case 100 of FIG. 1 in which a front cover 102 is removed from the back cover 104, exposing the collectible 106 seen therein, according to embodiments described herein.

Exemplary embodiments described herein are configured with a front cover 102 and a back cover 104. The front cover 102 may be connectable and/or removable from the back cover 104. In an exemplary embodiment, the front cover 102 may be attached, such as by a hinge to the back cover. In another exemplary embodiment, the front cover 102 may be removably attached to the back cover 104. As illustrated, the front cover 102 may be magnetically coupled to the back cover 104. According to an exemplary embodiment, the protective case 100 may comprise a securing mechanism configured to secure the front cover 102 to the back cover 104. For example, in an exemplary embodiment, the front cover 102 may have a first plurality of magnets 108. In an exemplary embodiment, the back cover 104 may have a second plurality of magnets 110. The first plurality of magnets 108 may have an opposite polarity to the second plurality of magnets 110. In an exemplary embodiment, each magnet of the first plurality of magnets 108 may have a mated pair to each magnet of the second plurality of magnets 110. For example, a first magnet of the first plurality of magnets 108 may mate with a first magnet of the second plurality of magnets 110. The mated pair of magnets may have opposite polarity so that each mated pair attract each other and retain the front cover 102 to the back cover 104. In an exemplary embodiment, a first magnet of a first cover (either the front cover 102 or back cover 104) may comprise two magnets of different polarity. A first magnet on an opposite cover (either the back cover 104 or front cover 102) may also comprise two magnets of different polarity and opposite to the first magnet of the first cover. Therefore, the pair of magnets of opposite polarity on the same side as well as opposing covers may be used to align the front cover 102 to the back cover 104.

The magnets may have different sizes, shapes, and/or positions on the front cover 102 and/or back cover 104. Exemplary embodiments of the magnets shown herein may have magnets in a T shape. However, the magnets may be circular, rectangular, L, T, X, linear, or other shape. The magnets may be positioned around the collectible 106 to secure the collectible 106 between the front cover 102 and the back cover 104. As illustrated, the magnets may be positioned at each corner of the collectible 106. The magnets may also or alternatively be positioned one, more, or all sides of the collectible 106.

Exemplary embodiments described herein optionally include an alignment feature and/or securing feature. The alignment feature may be used so that the front cover 102 is aligned with the back cover 104 when coupled together. The alignment feature may be one or more combination of features described herein. For example, the polarity and/or positions of the magnets may be used as an alignment feature. Projections 118 and/or indentations 112, 114 and/or flanged surfaces 116 may be used to position one cover relative to the other cover. The securing feature(s) may be used to more securely position the front cover 102 to the back cover 104. For example, a combination of mated features on opposing surfaces may be used to provide a secure connection of the front cover 102 to the back cover 104. In an exemplary embodiment, one cover may include projections 118, and the other cover may include indentations 112, 114 and/or apertures 120 configured to accept the projections 118. The insertion of the projections 118 into the indentations 112, 114 and/or apertures 120 may be used to secure and/or align one cover to the other.

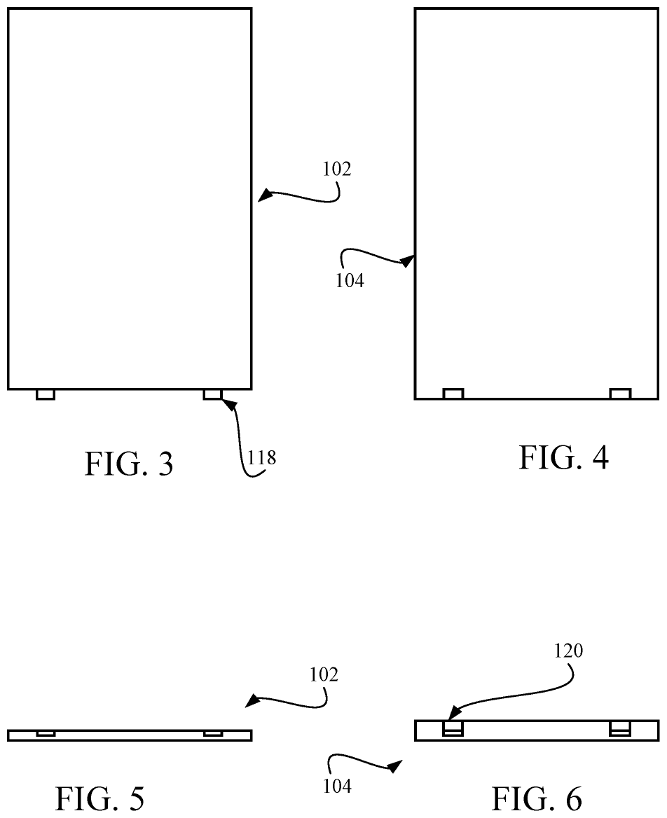

FIG. 3 illustrates a front plan view of an exterior side of the front cover 102 of a protective case 100 according to a first embodiment described herein. FIG. 4 illustrates a front plan view of an exterior side of the back cover 104 of the protective case 100 according to a first embodiment described herein. FIG. 5 illustrates a bottom plan view of the front cover 102 of the exemplary protective case 100 of FIG. 3 according to the first embodiment described herein. FIG. 6 illustrates a bottom plan view of the back cover 104 of the exemplary protective case 100 of FIG. 4 according to the first embodiment described herein. FIGS. 3 and 4 are the exterior sides of the front and back sides of the protective case 100 that are facing away from each other when connected, but in a disconnected configuration. Although the front 102 and back covers 104 described herein are described as transparent, FIGS. 3-6 are illustrated as if opaque. The interior features, including, for example, the magnets, are not illustrated so that the surface features of the covers 102, 104 may be more apparent.

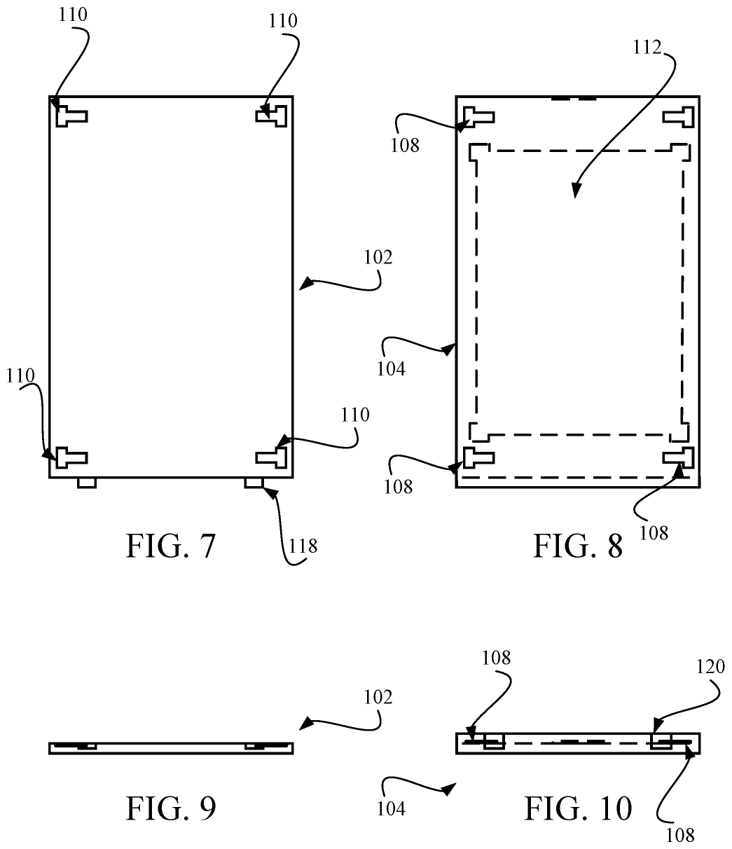

FIG. 7 illustrates a front plan view of an exterior side of the front cover 102 of the protective case 100 according to a second embodiment described herein. FIG. 8 illustrates a back plan view of an exterior side of the back cover 104 of the protective case 100 according to a second embodiment described herein. FIG. 9 illustrates a bottom plan view of the front cover 102 of the exemplary protective case 100 of FIG. 7 according to the second embodiment described herein. FIG. 10 illustrates a bottom plan view of the back cover 104 of the exemplary protective case 100 of FIG. 8 according to the second embodiment described herein. FIGS. 7-10 are the same views as FIGS. 3-6, but in which the interior features, such as the magnets 108, 110 and indentations 112, are illustrated. The magnets are illustrated as solid as the material of magnets may be more distinctive to the viewer. The other features, such as the flanges, indentations, holes, etc., are illustrated in dashed lines as the distinction to the viewer may be harder to observe. For example, the indentations of a transparent material may be difficult to observe by the user. The appearance for these features may therefore not be immediately viewable by a user.

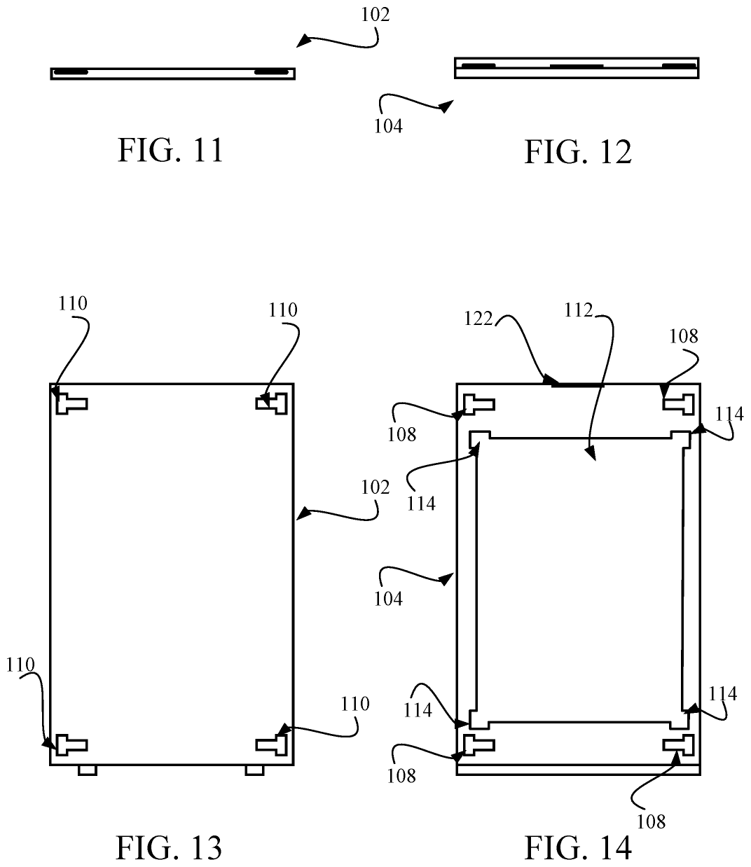

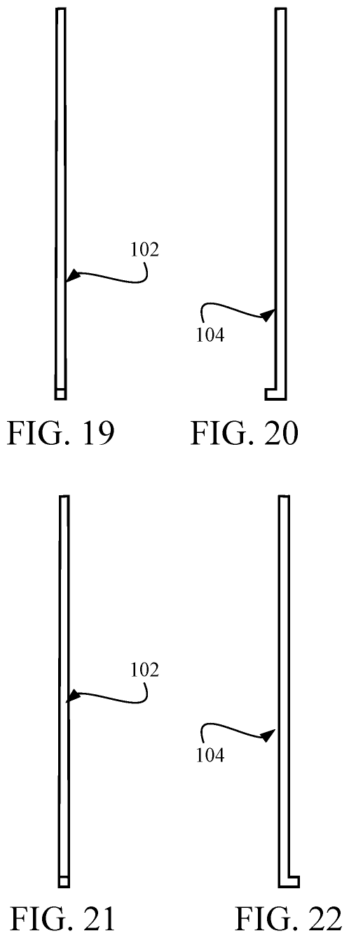

FIG. 11 illustrates a top plan view of the front cover 102 of a protective case 100 of FIG. 3 according to the first embodiment described herein. FIG. 12 illustrates a top plan view of the back cover 104 of the protective case 100 of FIG. 4 according to the first embodiment described herein. FIG. 13 illustrates a back plan view of an interior side of the front cover 102 of the exemplary protective case 100 of FIG. 3 according to the first embodiment described herein. FIG. 14 illustrates a back plan view of an interior side of the back cover 104 of the exemplary protective case 100 of FIG. 4 according to the first embodiment described herein. FIG. 19 illustrates a first side plan view of the front cover 102 of the protective case 100 of FIG. 3 according to the first embodiment described herein. FIG. 20 illustrates a first side plan view of the back cover 102 of the protective case 100 of FIG. 4 according to the first embodiment described herein. FIG. 21 illustrates a second side plan view of the front cover 102 of the protective case 100 of FIG. 3 according to the first embodiment described herein. FIG. 22 illustrates a second side plan view of the back cover 104 of the protective case 100 of FIG. 4 according to the first embodiment described herein. FIGS. 11-14 and 19-22 are visualized like those of FIGS. 3-6 so that interior features are not illustrated so that the surface features are not obstructed.

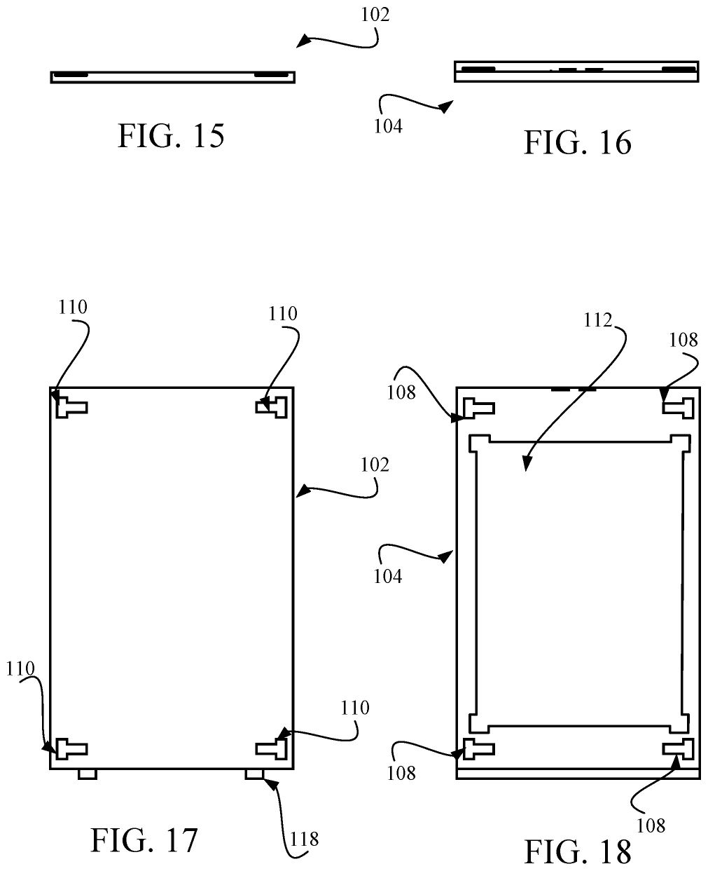

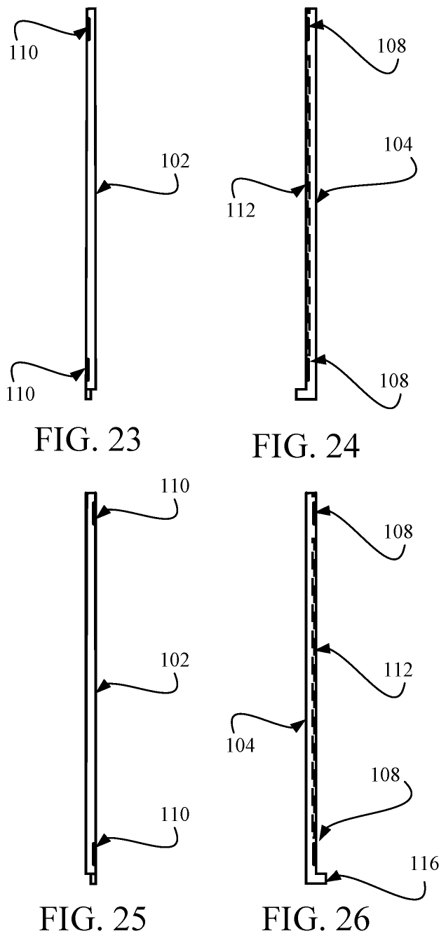

FIG. 15 illustrates a top plan view of the front cover 102 of a protective case 100 of FIG. 7 according to the second embodiment described herein. FIG. 16 illustrates a top plan view of the back cover 104 of the protective case 100 of FIG. 8 according to the second embodiment described herein. FIG. 17 illustrates a back plan view of an interior side of the front cover 102 of the exemplary protective case 100 of FIG. 7 according to the second embodiment described herein. FIG. 18 illustrates a back plan view of an interior side of the back cover 104 of the exemplary protective case 100 of FIG. 8 according to the second embodiment described herein. FIG. 23 illustrates a first side plan view of the front cover 102 of the protective case 100 of FIG. 7 according to the second embodiment described herein. FIG. 24 illustrates a first side plan view of the back cover 104 of the protective case 100 of FIG. 8 according to the second embodiment described herein. FIG. 25 illustrates a second side plan view of the front cover 102 of the protective case 100 of FIG. 7 according to the second embodiment described herein. FIG. 26 illustrates a second side plan view of the back cover 104 of the protective case 100 of FIG. 8 according to the second embodiment described herein. FIGS. 15-18 and 23-26 are visualized like those of FIGS. 7-10 so that the interior features are illustrated as either solid or dashed lines.

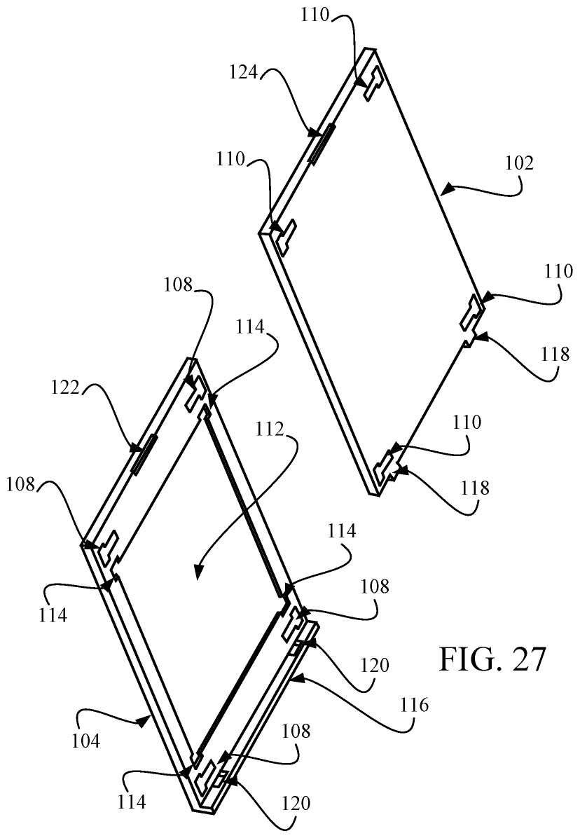

FIG. 27 illustrates a perspective view of a third exemplary embodiment of the protective case 100 in which a front cover 102 is removed from the back cover 104 exposing the interior sides of the front cover 102 and back cover 104 according to embodiments described herein. FIG. 27 illustrates an exemplary embodiment in which an additional indentation 114 is provided to assist the separation of the front cover 102 from the back cover 104.

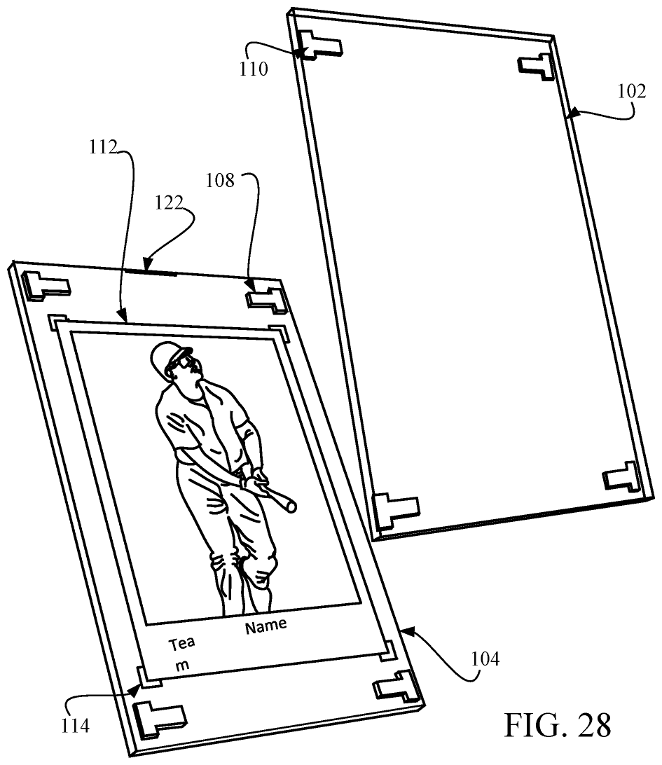

FIG. 28 illustrates a perspective view of a fourth exemplary embodiment of the protective case 100 in which a front cover 102 is removed from the back cover 104 exposing the collectible 106 retained within the protective case 100 according to embodiments described herein. FIG. 28 illustrates an exemplary embodiment in which the alignment feature and/or securing feature between the front cover 102 and the back cover 104 are not present.

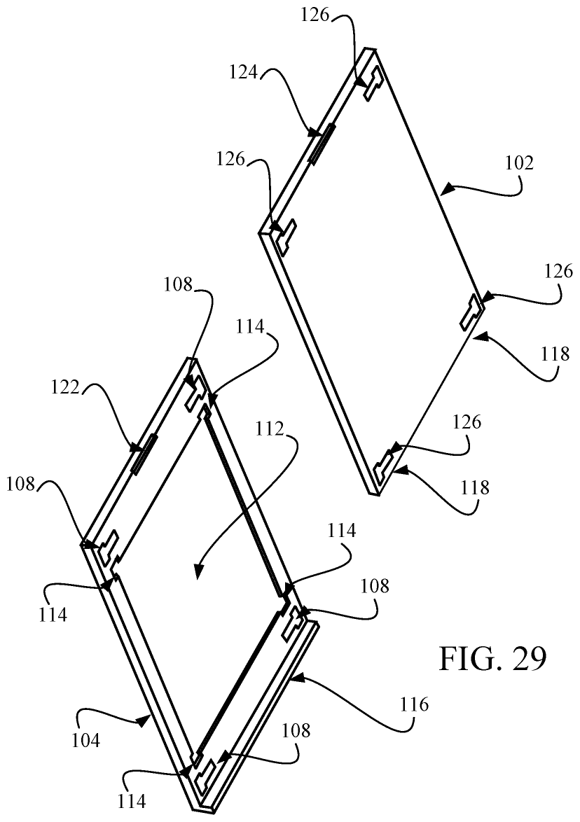

FIG. 29 illustrates a perspective view of a fifth exemplary embodiment of the protective case 100 in which a front cover 102 is removed from the back cover 104 exposing the collectible 106 retained within the protective case 100 according to embodiments described herein. FIG. 29 illustrates an exemplary embodiment in a plurality of magnets 108 are provided on one cover of the protective case and metal strips or attachment features 126 are provided on the opposite cover to attract the plurality of magnets 108.

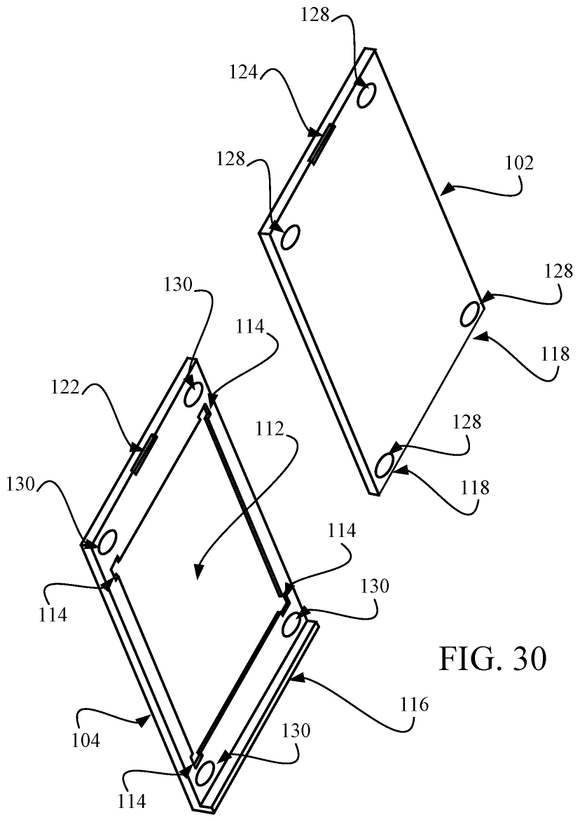

FIG. 30 illustrates a perspective view of a sixth exemplary embodiment of the protective case 100 in which a front cover 102 is removed from the back cover 104 to show the interior sides of the respective covers according to embodiments described herein. FIG. 30 illustrates an exemplary embodiment in which the magnetic and/or metallic connection pairs 128, 130 are a different shape.

In the exemplary embodiments shown and described herein, the protective case 100 may comprise a front cover 102 and a back cover 104.

The front cover 102 and the back cover 104 may comprise a durable material. In an exemplary embodiment, the front cover 102 and/or the back cover 104 may be hard and generally inflexible. The hard material may be used to provide a high level of protection for the enclosed collectible 106. Exemplary embodiments may alternatively cover different rigidity depending on the desired qualities of the protective case 100. For example, exemplary embodiments described herein may include flexible embodiments similar to conventional protective plastic pockets. Such configurations may not provide the same level of protection as a hard cover, however.

The front cover 102 and/or the back cover 104 may comprise a transparent material. In an exemplary embodiment, the front cover 102 may comprise a transparent material. The front cover 102 and/or the back cover 104 may be any combination of transparent, translucent, and/or opaque. The combination of transparency may depend on the collectible 106 being protected by the protective case 100. For example, if a trading card is being protected, the viewer may prefer to see the front and back of the enclosed card. Therefore, the front 102 and back covers 104 may be transparent. However, if the collectible 106 is a letter or document in which writing is only on one side of the document, the front cover 102 may be transparent and the back cover 104 may be opaque. The front cover 102 and/or back cover 104 may be ornamented to accentuate or ornament the collectible 106. For example, ornamentation may correspond to brands or teams associated with the collectible 106. The front cover 102 and/or back cover 104 may also or alternatively comprise ornamentations such as, e.g., boarders, colors etc.

Exemplary embodiments described herein may include a front cover 102 and a back cover 104 comprising a hard material configured to protect a collectible 106, such as, e.g., a trading card, sports card, picture, photo, document, and/or other collectible. The protective case 100 may be transparent and/or may comprise one or more magnets to surround a non-magnetic object to hold it in place.

Exemplary embodiments described herein are configured with a front cover 102 removably coupled to the back cover 104. The front cover 102 and/or the back cover 104 may comprise a plurality of magnets 108, 110 that may be configured to attract each other to retain the front cover 102 to the back cover 104. In an exemplary embodiment, a first plurality of magnets 108 on the back cover 104 may be configured to attract a second plurality of magnets 110 on the front cover 102. In an exemplary embodiment, each of the first plurality of magnets 108 may be configured to mate with each of the second plurality of magnets 110 so that one of the first plurality of magnets 108 creates a mated pair with one of the second plurality of magnets 110. Each mated pair may comprise opposing polarity of magnets to attract each other. In an exemplary embodiment, the first plurality of magnets 108 may include the same polarity while the second plurality of magnets 110 may include an opposing polarity. In an exemplary embodiment, the first plurality of magnets 108 may include different polarities while the second plurality of magnets 110 may include different polarities but opposite polarities to the first plurality of magnets 108 so that mated pairs are also opposing polarity.

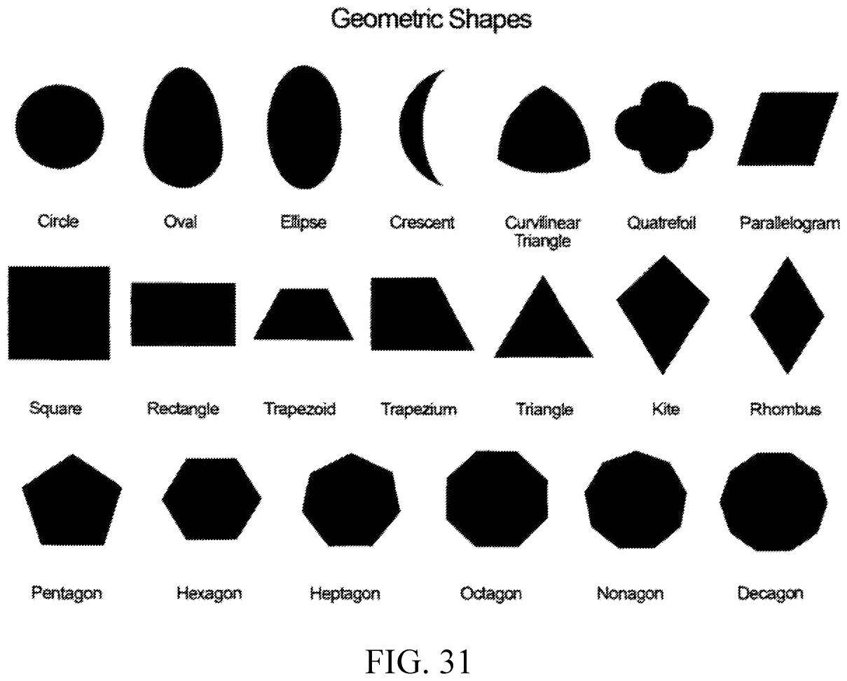

Each of the magnets may comprise one or more desired shape(s), position(s), polarity(ies), orientation(s), and/or combinations thereof. Exemplary embodiments described herein include magnets in any combination of shapes. For example, the magnets may be circular, rectangle, and/or have L- or T- or X-shaped layouts. Additionally or alternatively, the magnets may comprise one or more geometric shapes such as, but not limited to, those shown in FIG. 31, such as, e.g., a circle, an oval, an ellipse, a crescent, a curvilinear triangle, a quatrefoil, a parallelogram, a square, a rectangle, a trapezoid, a trapezium, a triangle, a kite, a rhombus, a pentagon, a hexagon, a heptagon, an octagon, a nonagon, a decagon, and/or other suitable geometric shapes and/or combinations thereof.

In an exemplary embodiment, the magnets may be positioned at the corners of the collectible 106 positioned therein. As described herein, a cover may include a recess to accommodate an inserted collectible 106. One or more magnets may be positioned at one, more, or all of the corners of the recess, and/or along one, more, or all of the sides of the recess, and any combination of sides and/or corners of the recess. In an exemplary embodiment, the selection of the magnets for the corners and/or sides may correspond to the position. For example, linear or rectangular magnets may be used along straight sides of the recession, and corner or T-shaped magnets may be positioned at corners of the recess.

As illustrated, four magnets may be provided on the front cover 102 and four magnets may be provided on the back cover 104. The magnets may be T-shaped and positioned adjacent to corners of the recess.

Exemplary embodiments of the protective case 100 described herein may comprise a front cover 102 and a back cover 104. The front cover 102 and/or back cover 104 may comprise a transparent material with magnets embedded on equal and opposite sides of respective covers. The magnets may comprise hard sided neodymium or rubber magnets. The magnet layout may vary in size and layout. As shown and described herein one configuration of the magnets may be laid out to surround the object retained within the case to hold the object (e.g., the collectible 106) in place. For example, the magnet layout may include all four corners or all four sides of the object or all corners and sides of the object or any combination of the corners and/or sides of the object. The layout may include magnets of straight line bar or rounded shapes. It may also include magnets of circular, rectangle, L or T or X shape layouts. The magnet layouts may be use to accentuate the object or boarder the object in an ornamental way to provide aesthetic value to the display.

Exemplary embodiments described herein may include different strengths of magnetic attractions between the front cover 102 and the back cover 104. For example, mated pairs of magnets may be used so that a magnet on one cover is attracted to one magnet on a back cover. In an exemplary embodiment, the magnets may be stronger and/or weaker by changing the composition of the magnets. For example, compositions may include different variations of magnetic material. For example, varying metallurgy to include more or less iron and aluminum to vary the strength of the magnetic hold. The metallurgy will hold stronger with more percentage of iron and hold less strong with more percentage of aluminum. In an exemplary embodiment, onc magnet may attract to a metal. FIG. 29 illustrates an exemplary protective case 100 in which a first plurality of magnets 108 are provided on one cover and a plurality of metals 126 on the opposite cover to attract to the magnets and couple the covers.

In an exemplary embodiment, the front cover 102 and/or back cover 104 may include an indentation 112. The indentation 112, as illustrated is a recess in the front cover 102, the back cover 104, or both the front cover 102 and the back cover 104. The indentation 112 may have a perimeter shape corresponding to the perimeter of the collectible 106 to be retained within the protective case 106. As illustrated, the recess may be configured to receive a trading card or other suitable collectible 106. The recess is shown as a rectangular-cubic recess of approximately the same size or just larger than an outer perimeter of the rectangular shape of a trading card. It is noted, however, that recesses of other sizes and/or shapes may be incorporated, while maintaining the spirit and functionality of the present disclosure. As illustrated, the recess may be on an interior side of the back cover 104. The recess may be shaped and/or contoured to accommodate any desired collectible 106.

In an exemplary embodiment, the front cover 102 and/or back cover 104 having an indentation 112 may comprise a secondary indentation 114 configured to assist in the insertion and/or removal of the collectible 106 within the indentation 112. The secondary indentation(s) 114 may be adjacent to and/or an extension of the indentation 112 so that the indentation extends beyond the shape and/or size of the collectible's perimeter at a portion of the perimeter of the indentation 112. As illustrated, the secondary indentation(s) 114 may be at one, more, or all of the corners of the indentation 112 so that a corner of the collectible may be accessed and removed from the insertion 112 more easily without damaging the collectible 106.

As illustrated, the back cover 104 may comprise an indentation 112 on an interior side of the back cover 104, facing an interior side of the front cover 102. The indentation 112 may be rectangularly shaped and recessed partially into the interior surface of the back cover 104. The back cover 104 may comprise one or more secondary indentations 114. The secondary indentation(s) 114 may be an extension of the indentation 112. For example, the secondary indentation(s) 114 may extend from the corners of the indentation 112. The secondary indentation(s) may be the same depth and/or a deeper depth than the indentation 112. As illustrated, the secondary indentation(s) 114 may comprise a rectangular shape, square shape, and/or other suitable shape and be positioned to overlap the corners of the indentation 112.

In an exemplary embodiment, the protective case 100 may comprise an opening 122. The opening 122 may be positioned along an exterior edge of the protective case 100 and may be positioned along an edge of one or both of the covers on a side facing the opposite cover. The opening 122 may be an indentation at the corner of a cover to assist in separating one cover from the other cover. For example, the back cover 104 may comprise a first opening 122 and/or the front cover 102 may comprise a second opening 124. The opening 124 on the front cover 102 and opening 122 may be aligned. The opening 122 may be an indentation from an exterior edge and a side of the cover along the interior sides of the respective covers. The position and/or shape of opening 122 and/or 124 may be configured such that a user can insert a finger, fingernail, or object within opening 122 and/or 124 and leverage one cover away from the other cover.

In an exemplary embodiment, the protective case 100 may optionally comprise an alignment feature and/or securing feature. The alignment feature may be used so that the front cover 102 is aligned with the back cover 104 when the front cover 102 and back cover 104 are coupled together. The alignment feature may be one or more of a combination of features described herein. For example, the polarity and/or positions of the magnets may be used as an alignment feature. Projections and/or indentations and/or flanged surfaces may be used to position one cover relative to the other cover. The securing feature may be used to more securely position the front cover 102 to the back cover 104. For example, as illustrated, a combination of mated features on opposing surfaces may be used to provide a secure connection of the front cover 102 to the back cover 104. In an exemplary embodiment, one cover may include projections 118, and the other cover may include indentations 112, 114 and/or apertures 120 configured to accept the projections 118. The insertion of the projections 118 into the indentations 112, 114 and/or apertures 120 may be used to secure and/or align one cover to the other.

As illustrated, an exemplary protective case may comprise a front cover 102 and a back cover 104. The back cover 104 may comprise a flange 116 configured to assist in the alignment of the front cover 102 to the back cover 104. The flange 116 of the back cover 104 may extend toward the front cover 102 along a bottom edge of the back cover 104. As illustrated, the back cover 104 may comprise a generally flat plane, and the flange 116 may extend generally perpendicularly from the planar portion of the cover. According to an exemplary embodiment, the flange 116 may be configured to extent along a terminal end of the back cover 104.

As illustrated, an exemplary protective case 100 with a flange 116 may comprise one or more mated surface features so that the front cover 102 is configured to mate to the back cover 104 in a certain configuration and/or is configured to provide an additional securing connection of the front cover 102 to the back cover 104. As illustrated, the flange 116 on the back cover 104 may comprise aperture(s) 120. The front cover 102 may comprise corresponding projection(s) 118 configured to fit within the aperture(s) 120. Although mated features of an aperture 120 and mated projection 118 are illustrated, other mated features may also be used such as, e.g., indents/detents, etc.

In an exemplary embodiment, the protective case 100 may or may not comprise a hinge design on one side of the protective case 100 configured to assist with closing the protective case 100.

The protective case 100 described herein comprises one or more non-conventional configurations at least because of the use of non-conventional component parts and/or the shapes and designs. For example, exemplary embodiments may use hard removably mated covers that attach to each other in order to protect a collectible 106 inserted between the respective covers. Exemplary embodiments described herein provide a hard protective cover that is small or corresponds to a size of the collectible 106 for mobility and ease of transportation. Exemplary embodiments described herein may use magnets to removably couple a front cover 102 to a back cover 104 to create a protective case 100. The magnets may create an easy and efficient attachment mechanism that can provide selectable strength to attach one cover to the other. Exemplary embodiments may include alignment and/or securing features to provide easier attachment of one cover to the other.

Exemplary embodiments of the protective case 100 described herein may include a hard sided protective case for trading cards, sports cards, and/or other collectibles or pictures. The protective case 100 may be transparent and/or may comprise one or more magnets configured and positioned to surround a non-magnetic object to hold it in place. The protective case 100 may be configured to hold various objects (e.g., collectibles 106), such as, e.g., trading cards, sports cards, photos, comic books, magazines, vinyl records, documents, and/or other collectibles.

Exemplary embodiments of the protective case 100 described herein may include a front cover 102 and a back cover 104, where one or both covers may comprise a transparent material with magnets embedded on equal and opposite sides. The magnets may comprise hard-sided neodymium magnets, rubber magnets, and/or other suitable magnets. The magnet layout may vary in size and layout. As shown and described herein, one configuration of the magnets may be laid out to surround the collectible 106 retained within the protective case 100 to hold the collectible 106 in place. For example, the magnet layout may include all four corners or all four sides of the collectible 106 and/or all corners and sides of the collectible 106, and/or any combination of the corners and/or sides of the collectible 106. The layout may comprise one or more magnets of straight line bar magnets, rounded shapes, and/or other suitable magnets. It may also comprise magnets of circular shape, rectangular shape, L-shape, T-shape, or X-shape layouts, and/or other suitable shape. The magnet layouts may be configured to accentuate the collectible 106 and/or boarder the collectible 106 in an ornamental way to provide aesthetic value to the protective case 100.

In an exemplary embodiment, the protective case 100 may comprise one or more magnets on one side and metal on the equal and opposite side. If metal is used, the metal may comprise a varying metallurgy to include more or less iron and/or aluminum to vary the strength of the magnetic hold. The metallurgy will hold stronger with more percentage of iron and hold less strong with more percentage of aluminum.

The protective case 100 may or may not comprise a hinge design on one side of the protective case 100 to assist with closing the protective case 100.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this present disclosure have been fully described with reference to the accompanying drawings, it is to be noted that various changes and modifications will become apparent to those skilled in the art. Such changes and modifications are to be understood as being included within the scope of embodiments of this present disclosure as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the present disclosure in diverse forms thereof.

What is claimed is:

1. A protective case, comprising:
a front cover;
a back cover removably coupled to the front cover,
wherein the front cover and the back cover, when coupled, form a recess configured to receive an object for insertion therein;
a securing mechanism, coupled to the front cover and the back cover, configured to removably couple the front cover to the back cover.

2. The protective case of claim 1, wherein the securing mechanism comprises a plurality of magnets inserted in the front cover.

3. The protective case of claim 2, wherein the securing mechanism comprises a plurality of metal portions inserted in the back cover that are positioned to align with the plurality of magnets inserted in the front cover when the front cover is coupled to the back cover.

4. The protective case of claim 3, wherein the metal portions are magnetic.

5. The protective case of claim 1, wherein the recess comprises an indentation in the back cover shaped to accommodate the object.

6. The protective case of claim 5, wherein the back cover comprises one or more second indentations.

7. The protective case of claim 6, wherein:
the indentation is rectangular in shape, and
a portion of each of the one or more second indentations overlaps with the indentation so that the one or more second indentations extends a perimeter of the indentation.

8. The protective case of claim 7, wherein the back cover comprises a flange extending along a terminal end of the back cover.

9. The protective case of claim 8, wherein the flange comprises one or more apertures.

10. The protective case of claim 9, wherein:
the front cover comprises one or more protections, and
the one or more projections are configured to be positioned in the one or more apertures.

11. The protective case of claim 10, wherein the front cover and the back cover are rigid.

12. The protective case of claim 11, wherein the front cover is transparent.

13. The protective case of claim 11, wherein the front cover and the back cover are transparent.

14. The protective case of claim 13, wherein the securing mechanism comprises a plurality of magnets inserted in the front cover.

15. The protective case of claim 14, wherein the plurality of magnets are T-shaped.

16. The protective case of claim 1, wherein the back cover comprises an opening.

17. The protective case of claim 16, wherein the opening comprises an indentation configured to assist in separating the front cover from the back cover.
